(19) United States
(12) Patent Application Publication
(10) Pub. No.: US 2020/0311569 A1
(43) Pub. Date: Oct. 1, 2020

(54) LOW LATENCY AND HIGH THROUGHPUT INFERENCE

(71) Applicant: Vathys, Inc., Portland, OR (US)

(72) Inventor: Tapabrata Ghosh, Portland, OR (US)

(21) Appl. No.: 16/365,475

(22) Filed: Mar. 26, 2019

(51) Int. Cl. G06N 5/04; G06N 20/00; G06N 3/08

(52) U.S. Cl. CPC G06N 5/04; G06N 3/08; G06N 20/00

(57) ABSTRACT

Disclosed are systems and methods for machine learning accelerators using a semantic pipeline technique to reduce latency while maintaining high throughput and high hardware utilization rates. In one embodiment, the computational graph of a deep learning workload is sliced into pipeline stages and data is processed as it arrives at the accelerator and is ready for processing.

### BACKGROUND

### Field of the Invention

This invention relates generally to the field of artificial intelligence processors and more particularly to machine learning accelerators.

### Description of the Related Art

The performance of machine learning hardware and underlying algorithms are constraint by competing design trade-offs. For example, sometimes machine learning workloads and input data are processed in batches to increase hardware utilization rates and improve throughput. However, increased hardware utilization rate and throughput comes at the expense of delay as the machine learning system waits for input data in batches to be generated, received, read or otherwise made available for the next stage of processing within the machine learning algorithm. Existing systems have not achieved low latency while maintaining high hardware utilization rates. Proposed are systems and methods that maintain near-ideal or high hardware utilization rates in machine learning processing while achieving low latency and high throughput.

### SUMMARY

In one aspect of the invention a method of processing deep learning inference workloads in a processor is disclosed. The method includes: receiving at a processor a plurality of input data, wherein each input data is received at different times; grouping the received input data into a plurality of input data units; dividing a computational graph of a deep learning workload into a plurality of processing pipeline stages; as a data unit arrives at the processor, processing the input data unit in the plurality of pipeline stages from one pipeline stage to a next pipeline stage; and outputting the processed data unit.

In some embodiments, the plurality of pipeline stages comprise: a first pipeline stage, one or more intermediary pipeline stages, and a final pipeline stage, and wherein processing the input data in the plurality of pipeline stages comprises: the first pipeline stage receiving an input data and outputting an activation map; the intermediary pipeline stages receiving the activation map and processing the activation map from one intermediary pipeline stage to a next intermediary pipeline stage and outputting an intermediary activation map to the final pipeline stage, and the final pipeline stage processing the intermediary activation map and outputting the processed data unit.

In some embodiments, each pipeline stage comprises a layer of a neural network and processing the input data unit comprises performing operations of the layer on the input data unit.

In one embodiment, each data unit comprises a received input data.

In another embodiment, the deep learning workload comprises an inference deep learning workload and the outputted processed unit is used in an inference application.

In some embodiments, the input data is data received from one or more of: a sensor measuring or detecting a physical parameter, a rolling shutter camera, a radar detector, a LIDAR scanning and detection mechanism, and a server storing high frequency day trading data.

In one embodiment, input data comprises a portion of a point cloud.

In another embodiment, each pipeline stage comprises one or more layers of a neural network.

In one embodiment, the method further includes: performing the computations of each pipeline stage in a sub-processor of the processor assigned to that pipeline stage; and storing in adjacent or physically close memory regions data associated with the performing of the computations of each pipeline stage.

In one embodiment, the method further includes: storing data associated with the plurality of pipeline stages in adjacent or physically close memory regions; and assigning computations of a pipeline stage to a sub-processor of the processor near or adjacent to a sub-processor performing computations of a next pipeline stage, wherein the assigned sub-processors are near or adjacent to memory regions where the sub-processor's pipeline stage data is stored.

In another aspect of the invention, a deep learning inference accelerator is disclosed. The accelerator includes: a plurality of processor cores, each assigned to a pipeline stage of a plurality of pipeline stages and configured to process the pipeline stage, wherein the plurality of pipeline stages together comprise the computational graph of a deep learning inference neural network and the plurality of processor cores are configured to: receive a plurality of input data units at different times; as a data unit arrives at a processor core, process the data unit in a pipeline stage assigned to the processor core and output the processed data to a next pipeline stage and associated processor core until the data unit is processed through the plurality of the pipeline stages; and generate an output based at least partly on output of the processing of the input data through the plurality of pipeline stages.

In one embodiment, each pipeline stage comprises a layer of the neural network and the processing in the pipeline stage comprises performing operations of the layer on the input data unit.

In some embodiments, the plurality of input data is received from one or more of: a sensor measuring or detecting a physical parameter, a rolling shutter camera, a radar detector, a LIDAR scanning and detection mechanism, and a server storing high frequency day trading data.

In another embodiment, adjacent or nearby processors are assigned to adjacent or nearby pipeline stages.

In one embodiment, the accelerator further includes a memory circuit configured to store data associated with the processing of each pipeline stage, wherein the data is stored in adjacent or nearby memory regions for near or adjacent pipeline stages.

In another embodiment, the data associated with the processing of each pipeline comprises weights and activation maps.

In some embodiments, one or more pipeline stages are skipped.

In another embodiment, the neural network comprises a CNN.

In one embodiment, an input data unit comprises an image.

Another embodiment includes an autonomous vehicle including the disclosed accelerator.

### BRIEF DESCRIPTION OF THE DRAWINGS

These drawings and the associated description herein are provided to illustrate specific embodiments of the invention and are not intended to be limiting.

FIG. 1 illustrates a diagram of an example deep learning (DL) workload and an associated processor designed to handle the workload.

FIGS. 2A-2F illustrate semantic pipelining method of processing DL workloads and the state of the workload when hardware is configured to perform the method.

FIG. 3 illustrates a diagram of semantic pipelining technique which can be used in hardware designed to handle artificial intelligence (AI) processing, such as processing a DL inference workload.

FIG. 4 illustrates a diagram of neural network processing accelerator whose operations of lockstep processing can be improved according to the described embodiments.

FIG. 5 illustrates an AI accelerator utilizing a spatial model of computation and the semantic pipeline processing according to the described embodiments.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

### DEFINITIONS

“Batch size” can refer to the number of input samples processed before a neural network model is updated.

“Compute utilization,” “compute utilization rate,” “hardware utilization,” and “hardware utilization rate,” can refer to the utilization rate of hardware available for processing neural networks, deep learning or other software processing.

“Throughput” can refer to the amount of data a system can process per unit of time.

In recent years, deep learning inference, neural network processing, machine learning, artificial intelligence (AI) and similar techniques have emerged as economically important computational workload for computer systems. Applications of artificial intelligence extend to many industries including self-driving autonomous or semi-autonomous vehicles, robotics, industry automation, manufacturing, shipping and transportation and many other fields. Hardware designed with the nature of AI computational tasks in mind can more efficiently perform the related tasks. For example, hardware accelerators according to the described embodiments can be employed to process deep learning or neural network processing tasks more efficiently.

When processing computational tasks related to neural network inference (e.g., feature detection and classification), achieving low latency is a highly desirable characteristic of the hardware and/or software performing the task. Counterintuitively, the end to end processing delay for an input sample through a neural network can be relatively small, especially when the neural network processing is performed on or with the aid of accelerator hardware designed for the neural network processing.

In some cases of neural network processing, the bulk of the latency comes from the hardware accelerator (or other hardware resources) waiting for enough inputs/samples to arrive before processing the incoming data and outputting the result to the next processing layer. For example, in some neural network processing, the incoming data is not processed until incoming data equal or greater than the batch size is arrived. In these systems, a higher batch size can increase compute utilization (a desirable outcome), but increase undesirable delay in the system (e.g., inference latency). One method for decreasing inference latency is to decrease the batch size, which results in less samples required to begin processing, thus lowering latency. However, this method can result in undesirable reduction in throughput. Furthermore, this method can result in an undesirable decrease in compute utilization of the limited compute resources of AI hardware (e.g., an inference accelerator when used). Thus, an uneasy compromise must usually be made in choosing the batch size to lower latency while simultaneously maintaining high throughput. In contrast, the disclosed systems and methods enable hardware accelerators, where both low latency and high throughput can be achieved with near-ideal hardware utilization rates.

In some implementations of deep learning and machine learning inference processors and processing, many input samples (e.g., input images) are aggregated into a batch and are processed together simultaneously one layer at a time to take advantage of the parallelism in input data and/or processing tasks. For example, with a batch size of four, four input images in a layer might be processed together simultaneously. Due to the increased number of input images, greater parallelism can be realized and exploited. For example, generalized matrix-vector (GEMV) basic linear algebra subprograms (BLAS) operations can often be turned into general matrix multiplication (GEMM) BLAS operations, making them amenable to acceleration on specialized hardware such as systolic arrays (e.g. Google TPU v1, NVIDIA Volta V100, and other accelerators). As described earlier, while this allows for utilizing parallelism in data, it can increase latency. Instead, the described embodiments utilize pipeline parallelism between layers.

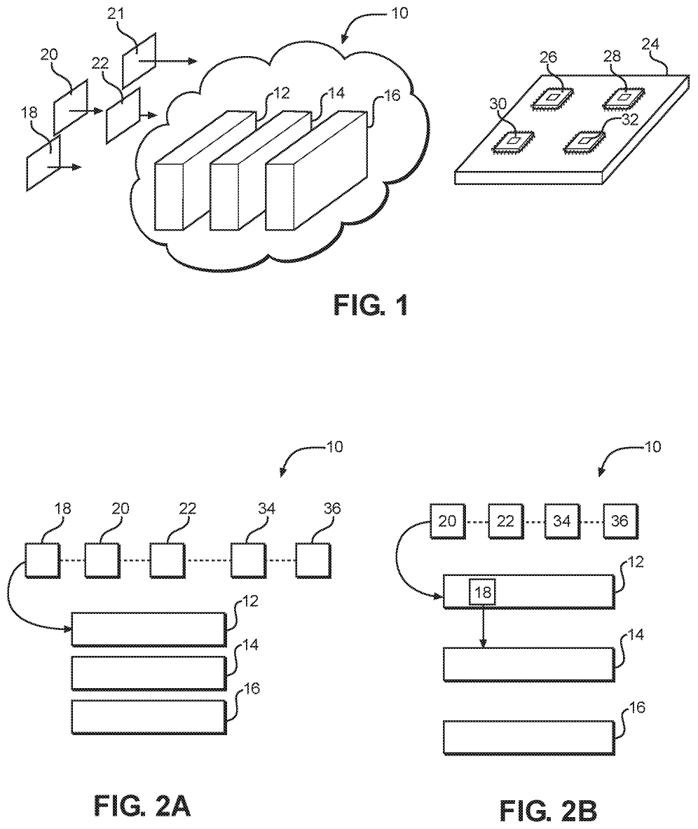

FIG. 1 illustrates a diagram of an example deep learning (DL) workload 10 and an example hardware 24 designed to handle the workload 10. The DL workload 10 can be a three-layered neural network, including layers 12, 14 and 16. Inputs 18, 20, 21 and 22 may be processed using the workload 10. An example of the DL workload 10 can be neural networks made to process image inference algorithms used in autonomous driving. However, the workload 10 can be any AI processing task and technique. The inputs 18, 20, 21 and 22 can be any form of input suitable for machine learning or artificial intelligence processing. Example inputs for the disclosed embodiments include, camera image stream, radar inputs, light imaging, detection and ranging (LIDAR) input, day-trading and financial data input, statistical data, and other data. Example input data can include various mathematical data structures, such as arrays, vectors, tensors, scalars, matrices, point clouds and other data structures that may be suitably processed using artificial intelligence techniques.

The hardware 24 can include general-purpose, standard or custom-made hardware used to process the workload 10. Examples of hardware 24 include central processing units (CPUs), multi-core processors, graphical processing units (GPUs), machine learning accelerators, hardware made for processing matrix operations in parallel and any hardware suitable and/or capable of handling artificial intelligence processing tasks. In the example shown, hardware 24 can include CPU cores 26, 28, 30 and 32, which may be employed for task or data parallelism utilization in processing the workload 10. Hardware 24 can additionally include various memory chips, such as random-access memory (RAM), read-only memory (ROM), short-term and long-term storage and/or other components to carry out its artificial intelligence processing.

When batch processing of batch size four is used, the hardware 24 waits for inputs 18, 20, 21 and 22 to arrive before starting to process them in parallel in layer 12, then layer 14, then layer 16 and then outputting the result. In batch processing, the resources of the hardware 24 are reserved until the inputs equal or greater than the batch size can arrive at the hardware 24. For example, to take advantage of parallel processing, processor cores 26, 28, 30 and 32 may be reserved to process layer 12, when the input data (e.g., images) 18, 20, 21 and 22 arrive at the hardware 24. Fewer or more processor cores may be used depending on the nature of the input data and the details of DL workload 10. In DL inference applications, while inference latency can be undesirably increased in proportion to batch size, greater hardware utilization is realized by using larger batch sizes. The disclosed semantic pipelining embodiments, allow for low latency AI processing (e.g., DL inference applications), while maintaining near-ideal hardware utilization and high throughput.

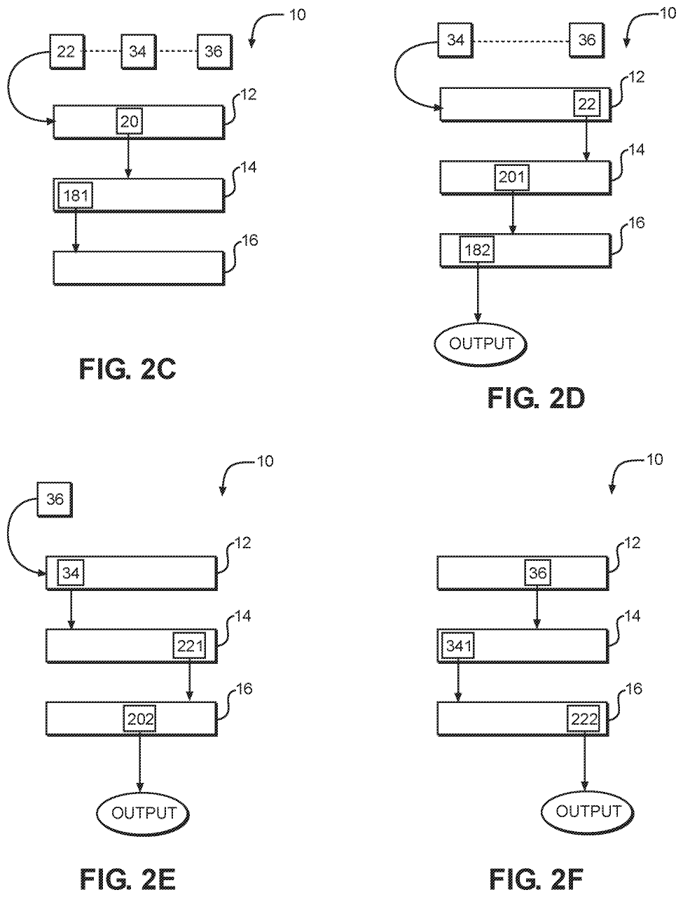

FIGS. 2A-2F illustrate semantic pipelining method of processing DL workloads and the state of the workload 10 when hardware 24 is configured to perform the method. In semantic pipelining, the computational graph of the workload 10 is divided into pipeline stages and each input is processed through the layers or pipeline stages of workload 10 as it arrives at the hardware 24. The resources of hardware 24 are only used as they are needed and are not tied up waiting for inputs to arrive, thereby increasing hardware utilization rates. Low latency is also achieved as the waiting time for all inputs in a batch to arrive is eliminated. As described, in DL inference processing, the waiting time for inputs in a batch to arrive makes up the majority of inference latency. The described embodiments, eliminate the waiting time for batch inputs to arrive and process inputs as they arrive, thereby substantially reducing latency.

FIG. 2A illustrates the workload 10 and its layers 12, 14 and 16. Inputs 18, 20, 22, 34 and 36 arrive in that order at different points in time, and are processed through the layers 12, 14 and 16 as they arrive. The number of inputs and layers shown are for illustration purposes only and can be more or fewer. Additionally, the described embodiments are not limited to layered networks and the described technology can be used in any data and pipeline stage. In some embodiments, sub-layers, sub-input pipelining, partial image input, streaming of input and other similar techniques can be used in the described embodiments.

FIG. 2B illustrates the state of the workload 10 at time stamp one where input 18 arrives at the hardware 24 and is processed in layer 12. FIG. 2C illustrates the state of workload 10 at time stamp two when input 20 arrives at hardware 24 and is processed in layer 12. The output of the processing of data unit 18 is data unit 181 and is processed in layer 14. FIG. 2D illustrates the state of the workload 10 at time stamp three when input 22 arrives at the hardware 24 and is processed in layer 12. The output of the processing of data unit 20 is data unit 201 and is processed in layer 14. The output of the processing of data unit 181 is data unit 182 and is processed in layer 16 and outputted. In time stamp three, the pipeline formed by processing in layers 12, 14 and 16 has reached steady state, where the pipeline is fully filled, high hardware utilization and low latency is achieved.

FIG. 2E illustrates the state of workload 10 at time stamp four when input 34 arrives at the hardware 24 and is processed in layer 12. The output of the processing of data unit 22 is data unit 221 and is processed in layer 14. The output of the processing of the data unit 201 is data unit 202 and is processed in layer 16 and outputted. FIG. 2F illustrates the state of workload 10 at time stamp five when input 36 arrives at the hardware 24 and is processed in layer 12. The output of the processing of data unit 34 is data unit 341 and is processed in layer 14. The output of the processing of data unit 221 is data unit 222 and is processed in layer 16 and outputted. The processing of the remaining or any additionally arriving data units in layers 12, 14 and 16 continues as described above and the result is outputted. In this manner, the hardware implementing the pipeline stages and processing described above is near-ideally utilized and latency is substantially reduced as the wait time for inputs to arrive is eliminated.

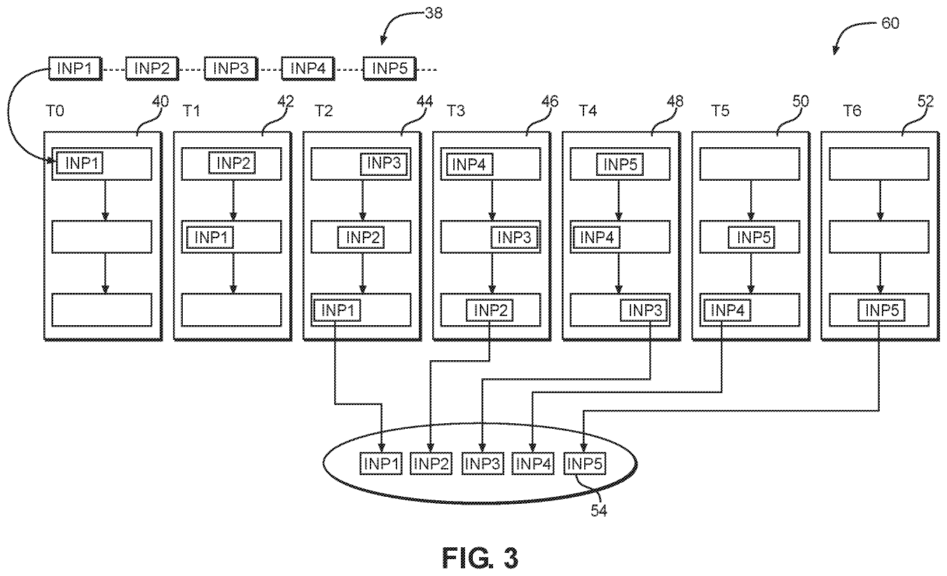

FIG. 3 illustrates a diagram of semantic pipelining technique 60 which can be used in hardware designed to handle AI processing, such as processing a DL inference workload. A stream of inputs 38 is received at an AI processing hardware such as hardware 24. Stream of inputs 38 can include data units, such as inp1, inp2, inp3, inp4, and inp5 as shown. Five inputs are shown for brevity of description and the described technique can be extended to fewer or more than five inputs in a continuous stream of input. The stream of inputs 38 can be sensor data, camera readout, or any other inputs suitable for AI processing.

The semantic pipelining techniques 60 is shown with pipeline stages 40, 42, 44, 46, 48, 50 and 52. Each pipeline stage can be the state of the hardware and/or memory processing the semantic pipelining technique 60 at different time stamps. Pipeline stage 40 is first in time, pipeline stage 42 is second in time and so forth. While pipeline stage 52 is the last pipeline stage shown, additional pipeline stages are possible as additional inputs 38 may arrive at the system implementing the semantic pipelining technique 60.

In the example shown, each pipeline stage includes three processing layers, the output of each layer is inputted in the next layer and so forth until the last layer processes its input and outputs the result to output 54. Fewer or more processing layers are possible depending on implementation. The processing layers could be layers in a neural network, deep neural network, convolutional neural network (CNN), sub-layers, activation maps, activation functions and any processing step as may be suitable for pipelining.

In the example shown, inp1 arrives at the hardware 24 first in time, at time stamp t0, and is processed through first, second and third layers at pipeline stages 40, 42 and 44, respectively, at time stamps t0, t1 and t2, respectively, and then outputted to output 54. Inp2 arrives at the hardware 24 at time stamp t1 and is processed through first, second and third layers at pipeline stages 42, 44 and 46, respectively, at time stamps t1, t2 and t3, respectively, and then outputted to output 54. Inp3 arrives at the hardware 24 at time stamp t2 and is processed through first, second and third layers at pipeline stages 44, 46 and 48, respectively, at time stamps t2, t3 and t4, respectively, and then outputted to output 54. Inp4 arrives at the hardware 24 at time stamp t3 and is processed through first, second and third layers at pipeline stages 46, 48 and 50, respectively, at time stamps t3, t4 and t5, respectively, and then outputted to output 54. Inp5 arrives at the hardware 24 at time stamp t4 and is processed through first, second and third layers at pipeline stages 48, 50 and 52, respectively, at time stamps t4, t5 and t6, respectively, and then outputted to output 54. The processing continues in similar fashion for any newly arrived input.

Arrived input can refer to input that has been processed, preprocessed or otherwise prepared for processing through an AI processor and/or AI algorithm, such as neural network, convolutional neural network (CNN), deep leaning, machine learning, point cloud processing and others. The described examples and embodiments can be applied to any data and AI processing pipeline stage. For example, in some embodiments, sub-layers and sub-inputs can be used. In the case of image-inference, an input can be a full image, or it can be a portion of an image (e.g., the top 1/10^{th} of an image). In some AI systems, input from cameras having rolling shutters can come in as a stream of data in row by row as read from the camera system. In another example, data streamed over a data bus, a peripheral computer interconnect (PCI) bus, PCI express (PCIe), universal serial bus (USB) may not arrive one image at a time and can arrive as part of an image transferred over limited wires over time.

Additionally, the described semantic pipelining embodiments are also compatible with batch processing. For example, instead of processing one input at a time in the pipeline stages of FIG. 3, hardware 24 can process two or more inputs at a time in each pipeline stage. In other words, the data width shown in FIG. 3 is one, but data widths of two or more are also possible. In other embodiments, when batching can cause an undesirable increase in latency, a smaller data width of one or only few inputs at a time can be used. For example, in image inference applications when the inputs are stream of data read from a camera, using batch sizes of 16 with 30 frames per second (fps) camera can lead to latency of more than 500 millisecond (ms), which can be unacceptable in some applications, such as autonomous driving. In such cases, the described semantic pipelining methods and devices can be used with smaller data width to—achieve low latency.

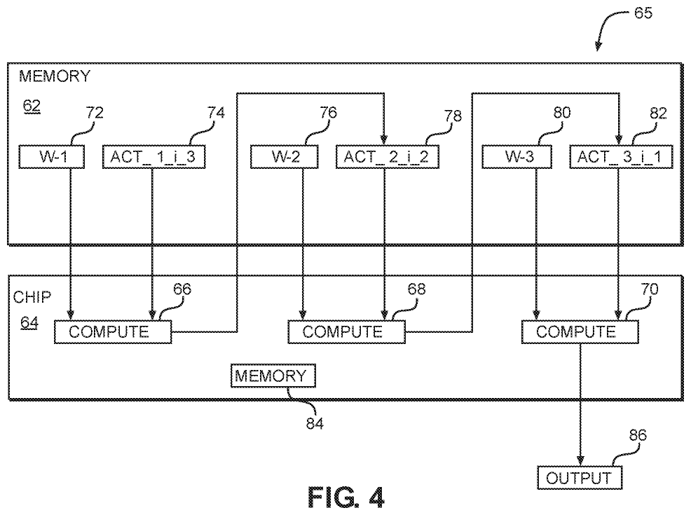

FIG. 4 illustrates a diagram of neural network processing accelerator 65 whose operations of lockstep processing can be improved according to the described embodiments. Accelerator 65 includes a memory unit 62 and a chip 64. While the memory unit 62 and the chip 64 are shown as separate components, they can be integrated as one component or as part of an integrated system. The chip 64 can include one or more compute units 66, 68 and 70 designed to handle neural network, deep learning, CNNs, machine learning and/or other AI processing tasks. In one embodiment, compute unites 66, 68 and 70 can be processor cores similar to processor cores 26, 28 and 30 in embodiment of FIG. 1.

The chip 64 can include an additional memory component 84 to aid the compute units 66, 68 and 70 in performing their functions, for example, by buffering or other memory functions. Memory 62 can include input data, sample data, activation functions, activation maps, weights, and/or other data related to AI processing. In the example shown, the memory unit 62 can include weights 72, 76 and 80, and activation layers 74, 78 and 82.

The accelerator 65 can utilize a lockstep model of computation as used in some machine learning hardware, such as Google® Tensor Processing Unit (TPU), NVIDIA® Volta V100 and similar devices. The chip 64 waits for input data (not shown) or associated pre-processing before parallel processing of the input data in compute units 66, 68 and 70. Output 86 can then be generated. As noted earlier, the compute units 66, 68 and 70 may have to delay the execution of their respective parallel processing until input data becomes available and the execution can be performed in parallel, thereby, delaying the output 86 and increasing latency.

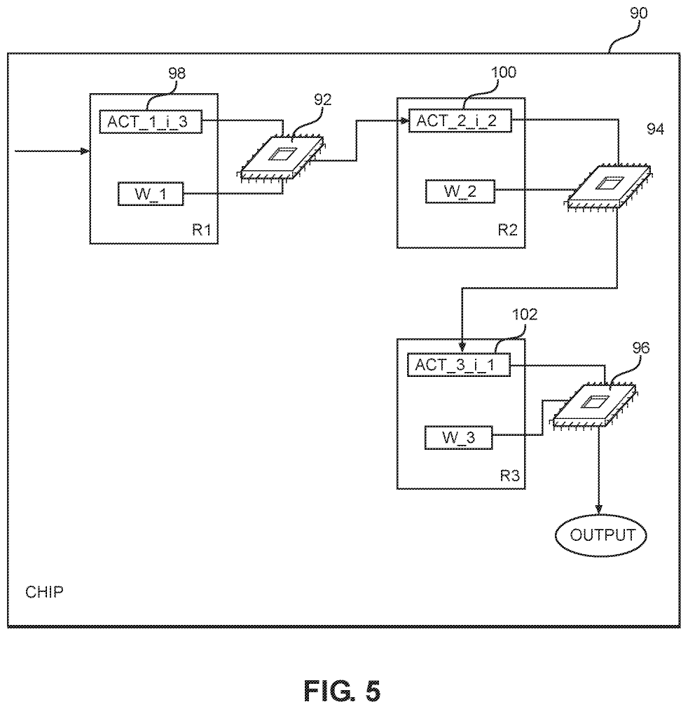

FIG. 5 illustrates an AI accelerator 90 utilizing a spatial model of computation and the semantic pipeline processing as described earlier. The accelerator 90 can be a chip designed to handle AI processing tasks, such as deep learning inference processing. The accelerator 90 can include memory regions R1, R2 and R3 and processing resources, such as processing cores 92, 94 and 96. Fewer or more memory regions and/or processing resources are possible depending on the implementation of an embodiment. Memory regions can store AI processing data locally and near the hardware resources intended to process them. In the example shown, memory region R1 can store activation map 98 and deep learning weight W_1, which are to be processed in, or used in processing of other data in processor core 92. Memory region R2 can store activation map 100 and deep learning weight W_2, which are to be processed in or used in processing of other data in processor core 94. Memory region R3 can store activation map 102 and deep learning weight W_3, which are to be processed in, or used in processing of other data in processor core 96.

Referring to FIGS. 2A-2E and FIG. 5, activation maps 98, 100 and 102 can be neural network layers 12, 14 and 16, respectively, where the output of one layer is used in the processing of the next. The accelerator 90 utilizes a semantic pipelining technique and can process the input data as they arrive. Processor core 92 can start processing the input data 18, 20, 22, etc. as they arrive in memory region R1 and output the resulting activation map to the next memory region. Pipeline processing (as described in relation to FIGS. 2A-2E and 3) and data produced by each pipeline stage can move across the memory regions of the accelerator 90 through adjacent and/or physically close memory regions with low latency and high throughput, thereby reducing resource and power consumption while significantly boosting performance.

Storing weights, activations and other AI processing data local and near their respective hardware and processing resources and keeping those regions and processing resources physically adjacent or near one another on the accelerator 90 improve various AI processing performance. Shorter wiring lengths can be used to transfer the output of one processing pipeline stage (e.g., a neural network layer or sub-layer) to the next. Shorter wire lengths allow for achieving low latency, high throughput, fast and low power transfer of data and higher bandwidths.

Semantic pipelining as applied to deep neural networks or other AI processing, divides the computational graph of the network or AI processing into various pipeline stages. The underlying mathematical operations of the DL neural network can be performed with or without utilizing traditional pipelining techniques.

In some embodiments, an entire input and/or activation map can be used as an input data unit and an entire layer in a deep neural network can be used as a pipeline stage. However, other divisions of input and/or layers are also possible. For example, input data units can be any input or a portion of a stream of an input (e.g., received sensor data, radar data, LIDAR data, etc.), any computable sub-division of an input and/or activation map, and the pipeline stages can be any part of the computational graph of a neural network. For example, a convolution layer can be split into at least two stages and each stage can be a pipeline stage. An activation map can be divided into at least two pieces and be used as input data units, where each data unit can be in different pipeline stages at different time stamps. In some CNNs, the convolutional layers do not need an entire input when data halos are used in the overlap regions. Therefore, an input image can be divided in smaller pieces and sent as input into the semantic pipeline. Image data stream from rolling shutters of cameras can be an example stream of input into the semantic pipeline. Another example of a divided input can be input from scanning mechanisms of LIDARs used for autonomous driving (e.g., galvanometer scanners), where parts of the input point cloud can be streamed into the semantic pipeline piece by piece.

In some applications, the input stream underlying the input data units are real time data from sensors measuring or capturing physical parameters (e.g., a camera in a LIDAR system). In such applications, the described methods and devices can be used to receive input data in parts and process them using the described semantic pipelines. Streaming the input piece by piece and in sub-divisions also reduces the local memory load as less data needs to be buffered before processing can begin. In the case of deep learning workloads, sub-input feeding, input streaming piece-by-piece and similar techniques are possible when the computational graph of the deep learning network is amenable to input slicing (e.g., as is the case with the computational graphs of CNNs).

In other embodiments, multiple layers or parts of layers can be fused together to form a pipeline stage. Additionally, input data can be aggregated and fused to form larger input data units and/or activation maps.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first, second, other and another and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of processing deep learning inference workloads in a processor, the method comprising:
receiving at a processor a plurality of input data, wherein each input data is received at different times;
grouping the received input data into a plurality of input data units;
dividing a computational graph of a deep learning workload into a plurality of processing pipeline stages;
as a data unit arrives at the processor, processing the input data unit in the plurality of pipeline stages from one pipeline stage to a next pipeline stage; and
outputting the processed data unit.

2. The method of claim 1, wherein the plurality of pipeline stages comprise: a first pipeline stage, one or more intermediary pipeline stages, and a final pipeline stage, and wherein processing the input data in the plurality of pipeline stages comprises: the first pipeline stage receiving an input data and outputting an activation map; the intermediary pipeline stages receiving the activation map and processing the activation map from one intermediary pipeline stage to a next intermediary pipeline stage and outputting an intermediary activation map to the final pipeline stage, and the final pipeline stage processing the intermediary activation map and outputting the processed data unit.

3. The method of claim 1, wherein each pipeline stage comprises a layer of a neural network and processing the input data unit comprises performing operations of the layer on the input data unit.

4. The method of claim 1, wherein each data unit comprises a received input data.

5. The method of claim 1, wherein the deep learning workload comprises an inference deep learning workload and the outputted processed unit is used in an inference application.

6. The method of claim 1, wherein the input data is data received from one or more of: a sensor measuring or detecting a physical parameter, a rolling shutter camera, a radar detector, a LIDAR scanning and detection mechanism, and a server storing high frequency day trading data.

7. The method of claim 1, wherein input data comprises a portion of a point cloud.

8. The method of claim 1, wherein each pipeline stage comprises one or more layers of a neural network.

9. The method of claim 1 further comprising:
performing the computations of each pipeline stage in a sub-processor of the processor assigned to that pipeline stage; and
storing in adjacent or physically close memory regions data associated with the performing of the computations of each pipeline stage.

10. The method of claim 1 further comprising:
storing data associated with the plurality of pipeline stages in adjacent or physically close memory regions; and
assigning computations of a pipeline stage to a sub-processor of the processor near or adjacent to a sub-processor performing computations of a next pipeline stage, wherein the assigned sub-processors are near or adjacent to memory regions where the sub-processor's pipeline stage data is stored.

11. A deep learning inference accelerator, comprising:
a plurality of processor cores, each assigned to a pipeline stage of a plurality of pipeline stages and configured to process the pipeline stage, wherein the plurality of pipeline stages together comprise the computational graph of a deep learning inference neural network and the plurality of processor cores are configured to:
receive a plurality of input data units at different times;
as a data unit arrives at a processor core, process the data unit in a pipeline stage assigned to the processor core and output the processed data to a next pipeline stage and associated processor core until the data unit is processed through the plurality of the pipeline stages; and
generate an output based at least partly on output of the processing of the input data through the plurality of pipeline stages.

12. The accelerator of claim 11, wherein each pipeline stage comprises a layer of the neural network and the processing in the pipeline stage comprises performing operations of the layer on the input data unit.

13. The accelerator of claim 11, wherein the plurality of input data is received from one or more of: a sensor measuring or detecting a physical parameter, a rolling shutter camera, a radar detector, a LIDAR scanning and detection mechanism, and a server storing high frequency day trading data.

14. The accelerator of claim 11, wherein adjacent or nearby processors are assigned to adjacent or nearby pipeline stages.

15. The accelerator of claim 11 further comprising a memory circuit configured to store data associated with the processing of each pipeline stage, wherein the data is stored in adjacent or nearby memory regions for near or adjacent pipeline stages.

16. The accelerator of claim 15, wherein the data associated with the processing of each pipeline comprises weights and activation maps.

17. The accelerator of claim 11, wherein one or more pipeline stages are skipped.

18. The accelerator of claim 11, wherein the neural network comprises a CNN.

19. The accelerator of claim 11, wherein an input data unit comprises an image.

20. An autonomous vehicle comprising the accelerator of claim 11.
